(19) United States
(12) Patent Application Publication
(10) Pub. No.: US 2019/0063149 A1
(43) Pub. Date: Feb. 28, 2019

(54) REEL FOR COLLECTING CORD OF WINDOW COVERING AND DRIVING MODULE HAVING THE SAME

(71) Applicant: NIEN MADE ENTERPRISE CO., LTD., TAICHUNG CITY (TW)

(72) Inventor: CHIH-YAO CHANG, TAINAN CITY (TW)

(73) Assignee: NIEN MADE ENTERPRISE CO., LTD., TAICHUNG CITY (TW)

(21) Appl. No.: 15/874,155

(22) Filed: Jan. 18, 2018

(30) Foreign Application Priority Data
Aug. 29, 2017 (CN) 201721090583.7

(51) Int. Cl. E06B 9/322; B65H 75/18

(52) U.S. Cl. CPC E06B 9/322; E06B 2009/3225; B65H 75/18

(57) ABSTRACT

A reel for collecting a cord of a window covering is disclosed, which includes a main body and a groove provided on the main body. While in use, the cord is wrapped around the main body after going along the groove, forming a plurality of cord loops, which include at least one first cord loop and a plurality of second cord loops. The first cord loop is at least partially received in the groove, with a part thereof protrudes out of the groove. The second loops are wrapped around the main body, and is sequentially arranged in a direction away from the groove. One of the second cord loops closest to the first cord loop abuts against the part of the first cord loop which protrudes out of the groove. A driving module for a window covering is also disclosed, which includes the aforementioned reel.

### BACKGROUND OF THE INVENTION

### 1. Technical Field

The present disclosure relates generally to a cord-collecting structure, and more particularly to a reel for collecting a cord of a window covering and a driving module having the reel.

### 2. Description of Related Art

A conventional reel for collecting a cord of a window covering typically has a cylindrical body with one end of the cord fixed thereon, so that the cord can be collected or released by different rotation directions of the reel. This type of reels is commonly used in cordless window coverings. Specifically, such a window covering usually includes a spring box provided in a headrail thereof. The spring box includes a cord-collecting assembly and an elastic assembly. The cord-collecting assembly includes at least one reel adapted to release or collect a lift cord of the window covering. That is, the reel could release or collect the lift cord in correspondence with the movement of the bottom rail, whereby to open or close the window covering. The elastic assembly can be operated along with the cord-collecting assembly, and includes a spiral spring providing a pull force which offsets the weight of the covering material of the window covering. Therefore, the bottom rail could stay at a desired position, so as to adjust an area blocked by the window covering.

However, whether it is one single reel being used for more than two lift cords, or multiple reels being used for multiple lift cords correspondingly and respectively, when only one of the lift cords happens to be rolled up, the counts of the cord loops formed by the lift cords would be different. If these cord loops of different counts overlap or twine each other, the outer diameters of the lift cords wrapping around the body of the reel would differ from each other, so that the lengths of the lift cords being collected may be also different, causing the bottom rail to be tilted, which hinders the covering material from being fully opened or closed. Further, if the overlapping or twining gets worse, the lift cord could be stuck while being released or rolled up, and the reel may not be able to rotate smoothly or even completely stuck as a result.

### BRIEF SUMMARY OF THE INVENTION

In view of the above, the primary objective of the present invention is to provide a reel for collecting cords of a window covering, which could tidily and sequentially arrange the cord wrapped therearound.

The reel for collecting cords of the window covering provided in the present invention includes a main body and a groove provided on the main body. While collecting the cord, the main body and the groove are adapted for the cord to go along the groove first and then wrap around the main body, forming a plurality of cord loops, which include at least one first cord loop and a plurality of second cord loops. The at least one first cord loop is at least partially received in the groove, with a part thereof protrudes out of the groove. The second loops are wrapped around the main body, and is sequentially arranged in a direction away from the groove, wherein one of the second cord loops closest to the first cord loop abuts against the part of the at least one first cord loop which protrudes out of the groove.

In one embodiment, the reel further includes a cord-fixing portion positioned immediately adjacent to the groove; the cord-fixing portion is adapted to fix one end of the cord, whereby to allow the cord to go along the groove and form the first cord loop.

In one embodiment, the reel further includes a first limit member and a second limit member respectively positioned at two ends of the main body. An outer diameter of the first limit member and an outer diameter of the second limit member are greater than an outer diameter of the main body, whereby the first limit member and the second limit member are adapted to limit the cord loops therebetween.

In one embodiment, the cord-fixing portion is an opening formed on the main body, the first limit member, or the second limit member. The opening is adapted to have the end of the cord is tucked therein.

In one embodiment, the opening includes a wide end and at least one narrow end. The wide end is adapted to have the end of the cord tucked therein and then moved toward the at least one narrow end, while the at least one narrow end is adapted to have the end of the cord fixed thereat.

In one embodiment, the reel further includes a guiding trough, which is recessed into the main body, and is close to the cord-fixing portion, wherein the guiding trough is adapted to guide the cord to form the second cord loops after forming the first cord loop.

The present invention further provides a driving module for a window covering, which includes a first wheel-shaped structure, a second wheel-shaped structure, at least one third wheel-shaped structure, an elastic member and at least one cord, wherein one end of the elastic member is fixedly connected to the first wheel-shaped structure in a manner that the end wraps around the first wheel-shaped structure, and another end of the elastic member fits around the second wheel-shaped structure, whereby the first wheel-shaped structure is operated with the second wheel-shaped structure through the elastic member, the third wheel-shaped structure is operated with the second wheel-shaped structure in a manner that the another end wraps around the second wheel-shaped structure, one end of the cord is fixedly connected to the third wheel-shaped structure, and the cord is adapted to wrap around the third wheel-shaped structure, or to be released from the third wheel-shaped structure; the third wheel-shaped structure includes a main body and a groove provided on the main body, wherein, while collecting the cord, the main body and the groove are adapted for the cord to go along the groove and then wrap around the main body, forming a plurality of cord loops, which include at least one first cord loop and a plurality of second cord loops. The at least one first cord loop is at least partially received in the groove, with a part thereof protrudes out of the groove. The second loops are wrapped around the main body, and is sequentially arranged in a direction away from the groove, wherein one of the second cord loops closest to the first cord loop abuts against the part of the at least one first cord loop which protrudes out of the groove.

In one embodiment, the third wheel-shaped structure further includes a cord-fixing portion positioned immediately adjacent to the groove; the cord-fixing portion is adapted to fix the end of the cord, whereby to allow the cord to go along the groove and form the first cord loop.

In one embodiment, the third wheel-shaped structure further includes a first limit member and a second limit member respectively positioned at two ends of the main body. An outer diameter of the first limit member and an outer diameter of the second limit member are greater than an outer diameter of the main body, whereby the first limit member and the second limit member are adapted to limit the cord loops therebetween.

In one embodiment, the cord-fixing portion is an opening formed on the main body, the first limit member, or the second limit member; the opening is adapted to have the end of the cord tucked therein.

In one embodiment, the opening includes a wide end and at least one narrow end. The wide end is adapted to have the end of the cord tucked therein and then moved toward the at least one narrow end, while the at least one narrow end is adapted to have the end of the cord fixed thereat.

In one embodiment, the third wheel-shaped structure further includes a guiding trough, which is recessed into the main body, and is close to the cord-fixing portion. The guiding trough is adapted to guide the cord to form the second cord loops after forming the first cord loop.

In one embodiment, at least one of the first limit member and the second limit member is a first toothed disk, and one end of the second wheel-shaped structure has at least one second toothed disk. The first and second toothed disks mesh with each other, whereby the third wheel-shaped structure and the second wheel-shaped structure are adapted to be operated along with each other through a meshing relationship between the first and second toothed disks.

With the above design, the cord would be forced to go around the groove to form the first cord loop, and therefore the second cord loops would be neatly and compactly arranged loop by loop.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1A is a front view of a reel of an embodiment of the present invention, which is adapted to collect a cord of a window covering;

FIG. 1B is a perspective view, showing a reel of another embodiment of the present invention;

FIG. 2 is a cross-sectional view along the 2-2 line in FIG. 1A;

FIG. 3 is a perspective view of a reel of yet another embodiment of the present invention;

FIG. 4 is a partial cross-sectional view of the reel shown in FIG. 3;

FIG. 5 is a front view of the reel shown in FIG. 3;

FIG. 6 is a perspective view of a spring box for a cordless window covering, wherein the spring box includes the reel shown in FIG. 3; and

FIG. 7 is a front view of a reel of still yet another embodiment of the present invention.

### DETAILED DESCRIPTION OF THE INVENTION

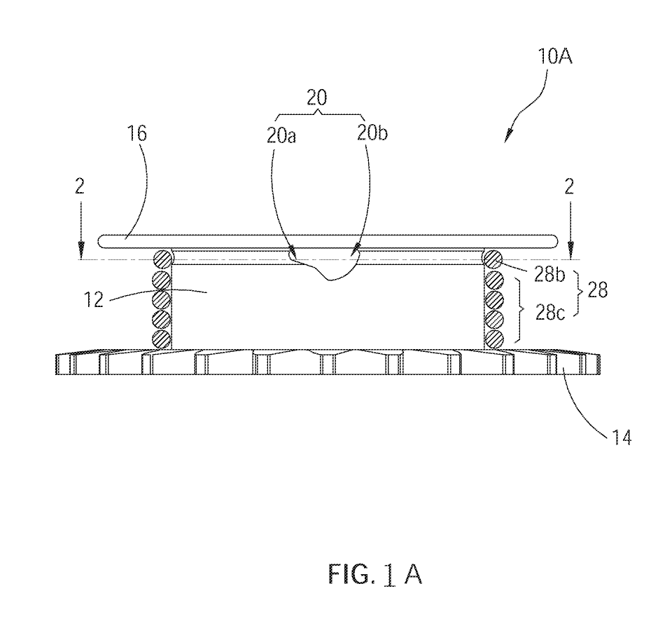

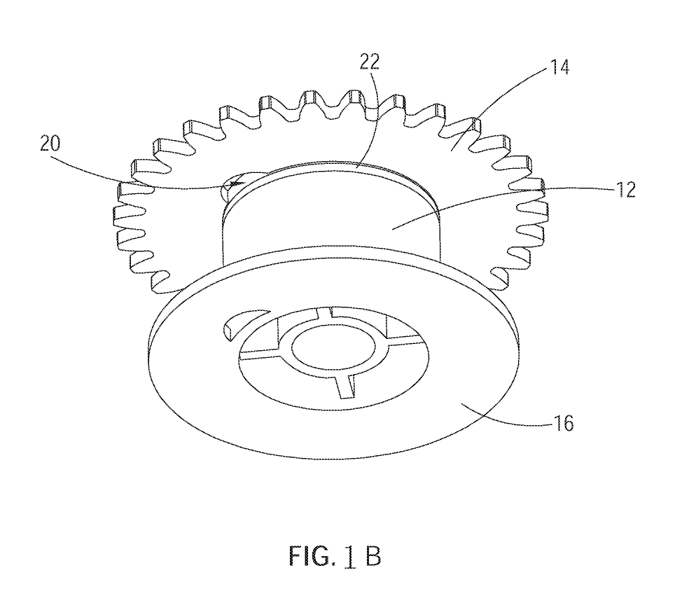

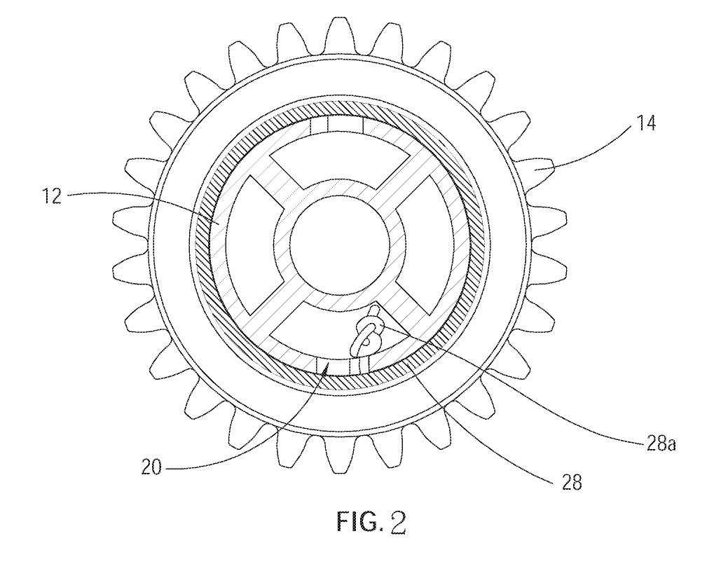

For easily understanding the present invention, several embodiments and accompanying drawings are illustrated as the following. As shown in FIG. 1A and FIG. 2, a reel 10A of an embodiment of the present invention for collecting at least one cord of a window covering includes a main body 12, a first limit member, a second limit member, a cord-fixing portion 20 and a groove 22, wherein the main body 12 is cylindrical. The first limit member and the second limit member are respectively positioned on two edges of the main body 12. In the current embodiment, the first limit member is a toothed disk 14 as an example, while the second limit member is a block disk 16 as an example. The outer diameters of the toothed disk 14 and the block disk 16 are both greater than the outer diameter of the main body 12. In other embodiments, the first limit member and the second limit member could be the other way around, i.e., the first limit member is a block disk and the second limit member is a toothed disk. Or, the first limit member and the second limit member could both be toothed disks as well. In another embodiment which has a reel positioned between a top plate and a bottom plate of a casing in a relative rotatable manner, the top plate and the bottom plate can be deem the first limit member and the second limit member, respectively.

In the present embodiment, the cord-fixing portion 20 and the groove 22 are both provided on the main body 12, and the cord-fixing portion 20 is close to the groove 22. The cord-fixing portion 20 is adapted to fix one end of a cord 28, whereby the cord-fixing portion 20 could be a start point of wrapping the cord 28 around the groove 22 and then the main body 12. The cord-fixing portion 20 is a through opening, and the end of the cord 28 could be tucked into the opening. In the current embodiment, the opening includes a wide end 20a and at least one narrow end 20b. The cord 28 could have a knot 28a tied at the end thereof, wherein the knot 28a could be tucked into the wide end 20a and moved toward the narrow end 20b, whereby the cord 28 could eventually get fixed by the narrow space between sidewalls of the narrow end 20b. At this time, the knot 28a would abut against an inner wall of the main body 12, so that the cord 28 would not be able to be pulled off from the main body 12. In other embodiments, the opening could be a round hole, which is adapted for the end of the cord to pass therethrough to be knotted behind the round hole, which could prevent the cord from being pulled out of the round hole. It is worth noting that, in addition to be provided on the main body 12, the cord-fixing portion 20 could be also provided on the toothed disk 14, as shown in FIG. 1B. Besides, the cord-fixing portion could be a cord-fixing trough positioned on the toothed disk or the block disk in other embodiments, which could be used to grasp the end of the cord.

In FIG. 1A, the cord 28 is wrapped around the main body 12 after going along the groove 22, forming a plurality of cord loops, wherein the cord loops includes at least one first cord loop 28b and a plurality of second cord loops 28c. In the current embodiment, by providing the toothed disk 14 and the block disk 16, the coils are restricted therebetween. When in use, the cord 28 would be wrapped around the main body 12 after going along the groove 22, wherein the segment of the cord 28 going through the groove 22 is defined as the first cord loop 28b. Furthermore, the first loop 28b would be partially received within the groove 22, with a part thereof protruding out of the groove 22. On the other hand, the segment of the cord 28 wrapping around the main body 12 is defined as the second cord loops 28c, wherein the second cord loops 28c would be arranged sequentially in a direction away from the groove 22. In the current embodiment, an outer diameter of the first cord loop 28b is less than an outer diameter of each of the second cord loops 28c. It is worthy noting that, one of the second cord loops 28c closest to the first cord loop 28b abuts against the part of the first cord loop 28b protruding out of the groove 22. In other words, with said part of the first cord loop 28b of the cord 28 protruding out of the groove 22, rest of the cord 28 would tightly abut against said part of the first cord loop 28b while being sequentially wrapped around the main body 12, whereby to form the second cord loops 28c.

In the present embodiment, two ends of the groove 22 communicate with the cord-fixing portion 20, so that the groove 22 and the cord-fixing portion 20 together form a circular structure around the main body 12. However, an extension length of the groove 22 on the main body 23 is not a limitation of the present invention. In other embodiments, the groove could have only one end communicating with the cord-fixing portion.

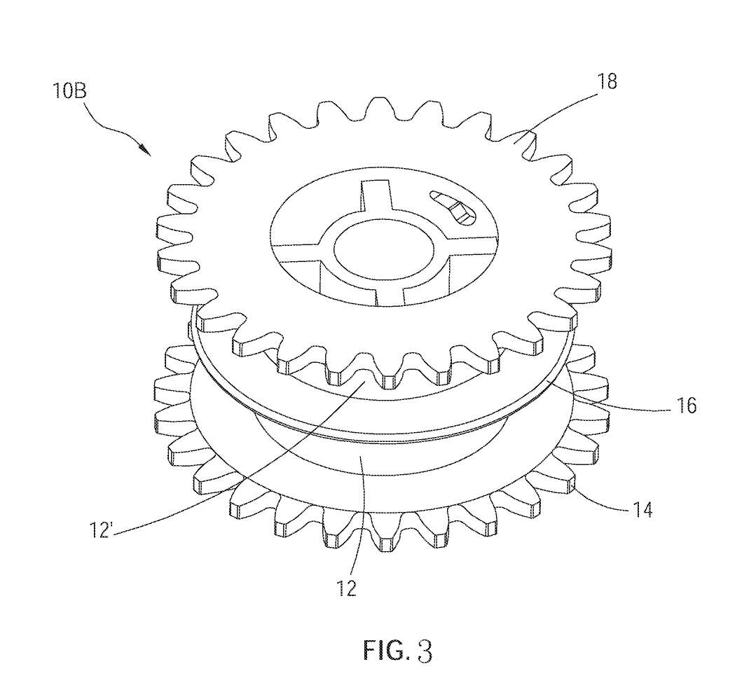

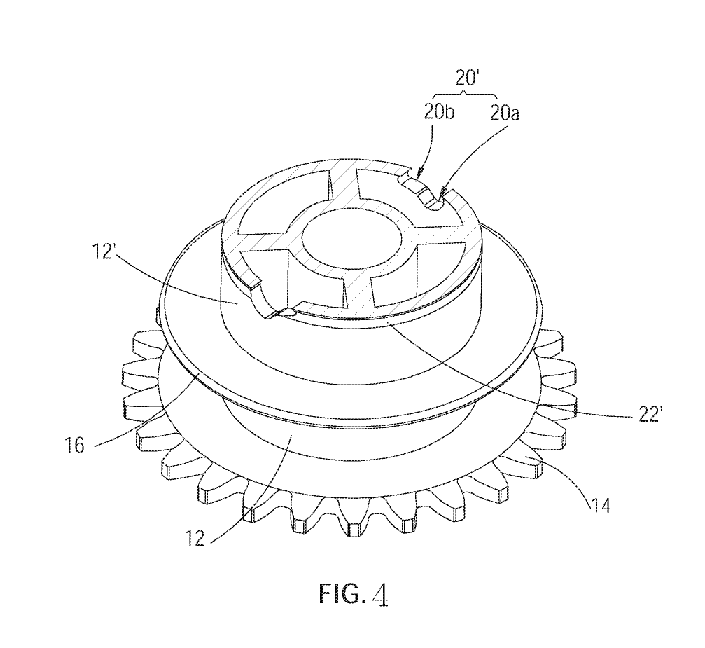

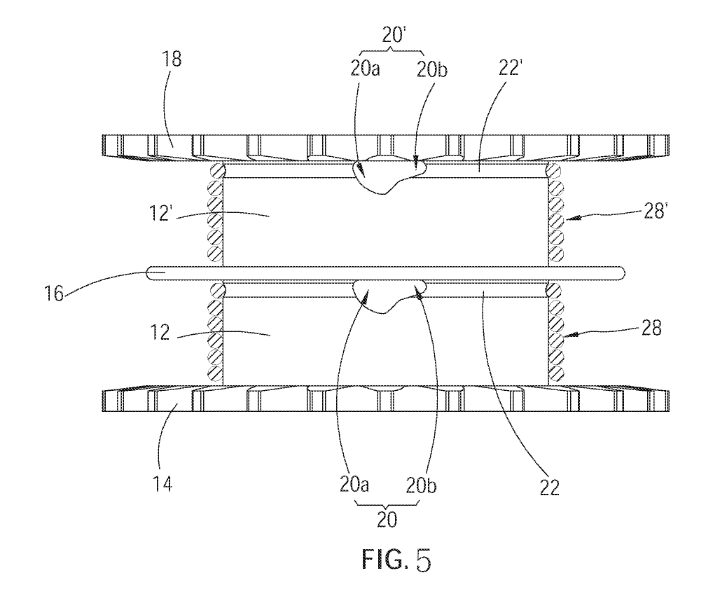

A reel 10B similar to said reel 10A is shown in FIG. 3 to FIG. 5, which includes the main body 12, the toothed disk 14 and the block disk 16, wherein the main body 12 is positioned between the toothed disk 14 and the block disk 16. The reel 10B further includes a main body 12′, a toothed disk 18, a cord-fixing portion 20′ and a groove 22′, wherein the main body 12′ and the main body 12 are co-axial, and the main body 12′ extends form the block disk 16 in an axial direction of the block disk 16, whereby one end of the main body 12′ is connected to the block disk 16, and another end thereof is connected to the toothed disk 18. The arrangements and structures of the cord-fixing portion 20′ and the groove 22′ on the main body 12′ are substantially the same as those of the cord-fixing portion 20 and the groove 22, so we are not going to describe them in details herein. It is worthy mentioning that, the cord-fixing portion 20 and the groove 22 are close to the block disk 16, and the cord-fixing portion 20′ and the groove 22′ are close to the toothed disk 18. Furthermore, the closer the groove 22 is to the block disk 16, and the closer the groove 22′ is to the toothed disk 18, the more preferable.

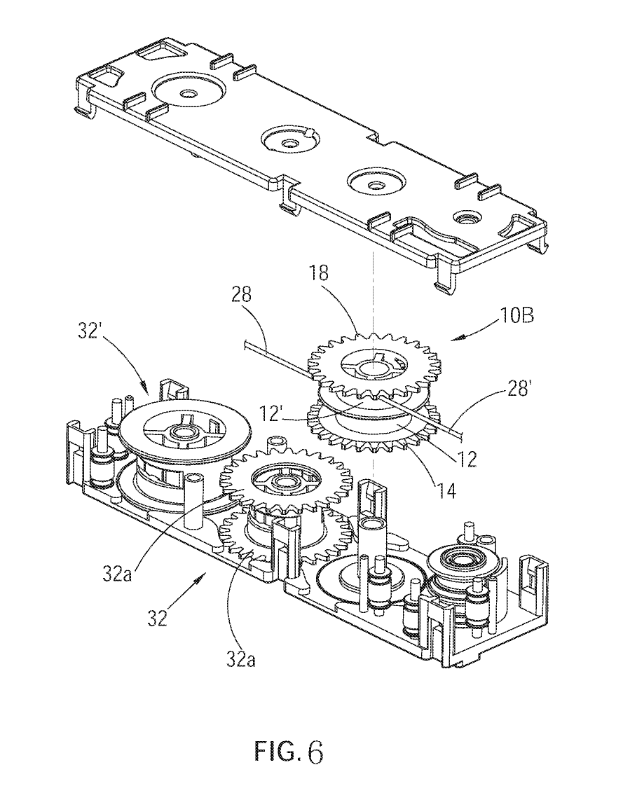

As shown in FIG. 6, a spring box for cordless window coverings is provided, and a cord-collecting assembly thereof includes said reel 10B mentioned in the above embodiment of the present invention. An elastic assembly of the spring box includes two rotatable drums 32, 32′ and a spiral spring (not shown), wherein the spiral spring has two ends respectively connected to the drums 32, 32′, and provides a pulling force to stay a bottom rail of the window covering at a desired position. However, the elastic assembly is a well-known technique, so its detailed structures will not be further described herein. In FIG. 6, there are two toothed disks 32a respectively positioned on the top and bottom of the drum 32 of the elastic assembly, and the two toothed disks 32a respectively mesh with the toothed disks 14, 18 of the reel 10B. The cords 28, 28′ pass through a headrail (not shown) and a covering material (not shown) of the window covering. More specifically, one end of the cord 28 is fixedly connected to the main body 12 of the reel 10B, and one end of the cord 28′ is fixedly connected to the main body 12′ of the reel 10B; on the other hand, another end of each of the cords 28, 28′ is fixedly connected to the bottom rail (not shown). Whereby, the total weight of the covering material and the bottom rail are supported by the cords 28, 28′.

When the window covering is fully opened, the bottom rail is at the lowest position, and at the same time, the cords 28, 28′ have been released from the reel 10B. When the bottom rail is pushed to move upward, the pulling force provided by the spiral spring of the elastic assembly would drive the drum 32 to rotate through the toothed disk 32a, and the reel 10B would be rotated simultaneously by the meshing between the reel 10B and the drum 32, so as to automatically and simultaneously collect the cords 28, 28′, i.e., to warp the cords 28, 28′ around the reel 10B. As mentioned above, when the cords 28, 28′ are collected by the reel 10B, the first cord loops of the cords 28, 28′ are respectively forced to fall into the corresponding grooves 22, 22′, so that the second cord loops of the cords 28, 28′ could be arranged sequentially, whereby the next cord loop would be tightly close to the previous cord loop, which would prevent the cord loops from overlapping or twining each other. Therefore, the lengths of the released (i.e., unwrapped) cords 28, 28′ would be substantially equal, so as to prevent the bottom rail from slanting in a longitude direction of the headrail. Whereby, the window covering could be fully opened or closed smoothly. It is worthy mentioning that, in the present embodiment, the reel 10B is installed in the spring box. However, the reel of the embodiment of the present invention could also be applied in any cord collecting device of the window covering.

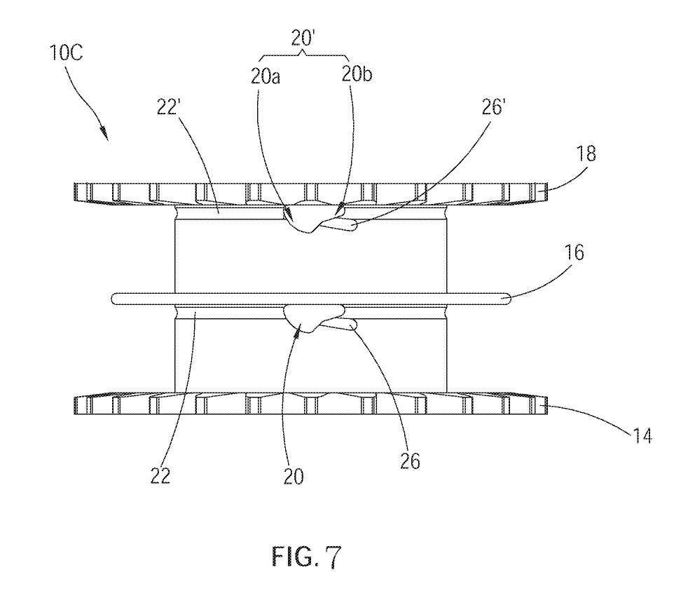

Furthermore, a reel 10C which is modified based on the structure of the reel 10B is shown in FIG. 7, wherein two guiding troughs 26, 26′ are further provided. In the present embodiment, the arrangement and the structure of the guiding trough 26 is the same as those of the guiding trough 26′, so we will only take the guiding trough 26 as an example for illustration in the following passages. One end of the guiding trough 26 communicates with the cord-fixing portion 20, and another end thereof is below the groove 22. In other words, the another end of the guiding trough 26 extends in a direction away from the groove 22. Furthermore, since the guiding trough 26 is immediately adjacent to the groove 22, once the first cord loop of the cord 28 formed around the reel 10C, the guiding trough 26 would guide rest of the cord 28 to keep wrapping around the reel 10C tightly close to the first cord loop, and so on, whereby a part of the second cord loops would fall into the guiding trough 26, so as to arrange the cord loops neatly and sequentially.

When the reel is driven to rotate, the first cord loop is forced to fall into the groove. As a result, rest of the cord would be only possible to wrap around the main body in the direction away from the groove, and would not go loosely upward because of being confined by the first limit member. Whereby, the next cord loop would be immediately adjacent to the previous cord loop. The cord could sequentially wrap around and cover the groove and the main body, so as to arrange the cord loops of the cord neatly and sequentially, whereby to prevent the cord loops from overlapping or twining each other. Therefore, the lengths of the cords on both sides would be substantially equal, so as to prevent the bottom rail from slanting in the longitude direction of the headrail.

It must be pointed out that the embodiments described above are only some preferred embodiments of the present invention. All equivalent structures which employ the concepts disclosed in this specification and the appended claims should fall within the scope of the present invention.

What is claimed is:

1. A reel for collecting a cord of a window covering, comprising:
a main body; and
a groove provided on the main body;
wherein, while collecting the cord, the main body and the groove are adapted for the cord to go along the groove first and then wrap around the main body, forming a plurality of cord loops, which include at least one first cord loop and a plurality of second cord loops; the at least one first cord loop is at least partially received in the groove, with a part thereof protrudes out of the groove; the second loops are wrapped around the main body, and is sequentially arranged in a direction away from the groove, wherein one of the second cord loops closest to the first cord loop abuts against the part of the at least one first cord loop which protrudes out of the groove.

2. The reel of claim 1, further comprising a cord-fixing portion positioned immediately adjacent to the groove; the cord-fixing portion is adapted to fix one end of the cord, whereby to allow the cord to go along the groove and form the first cord loop.

3. The reel of claim 2, further comprising a first limit member and a second limit member respectively positioned at two ends of the main body, wherein an outer diameter of the first limit member and an outer diameter of the second limit member are greater than an outer diameter of the main body, whereby the first limit member and the second limit member are adapted to limit the cord loops therebetween.

4. The reel of claim 3, wherein the cord-fixing portion is an opening formed on the main body, the first limit member, or the second limit member; the opening is adapted to have the end of the cord tucked therein.

5. The reel of claim 4, wherein the opening includes a wide end and at least one narrow end; the wide end is adapted to have the end of the cord tucked therein and then moved toward the at least one narrow end, while the at least one narrow end is adapted to have the end of the cord fixed thereat.

6. The reel of claim 2, further comprising a guiding trough, which is recessed into the main body, and is close to the cord-fixing portion, wherein the guiding trough is adapted to guide the cord to form the second cord loops after forming the first cord loop.

7. A driving module for a window covering, comprising a first wheel-shaped structure, a second wheel-shaped structure, at least one third wheel-shaped structure, an elastic member and at least one cord, wherein one end of the elastic member is fixedly connected to the first wheel-shaped structure in a manner that the end wraps around the first wheel-shaped structure, and another end of the elastic member fits around the second wheel-shaped structure in a manner that the another end wraps around the second wheel-shaped structure, whereby the first wheel-shaped structure is adapted to be operated with the second wheel-shaped structure through the elastic member; the third wheel-shaped structure is adapted to be operated with the second wheel-shaped structure; one end of the cord is fixedly connected to the third wheel-shaped structure, and the cord is adapted to wrap around the third wheel-shaped structure or to be released from the third wheel-shaped structure; the third wheel-shaped structure comprises:
a main body; and
a groove provided on the main body,
wherein, while collecting the cord, the main body and the groove are adapted for the cord to go along the groove and then wrap around the main body, forming a plurality of cord loops, which include at least one first cord loop and a plurality of second cord loops; the at least one first cord loop is at least partially received in the groove, with a part thereof protrudes out of the groove; the second loops are wrapped around the main body, and is sequentially arranged in a direction away from the groove, wherein one of the second cord loops closest to the first cord loop abuts against the part of the at least one first cord loop which protrudes out of the groove.

8. The driving module of claim 7, wherein the third wheel-shaped structure further comprises a cord-fixing portion positioned immediately adjacent to the groove; the cord-fixing portion is adapted to fix the end of the cord, whereby to allow the cord to go along the groove and form the first cord loop.

9. The driving module of claim 8, wherein the third wheel-shaped structure further comprises a first limit member and a second limit member respectively positioned at two ends of the main body; an outer diameter of the first limit member and an outer diameter of the second limit member are greater than an outer diameter of the main body, whereby the first limit member and the second limit member are adapted to limit the cord loops therebetween.

10. The driving module of claim 9, wherein the cord-fixing portion is an opening formed on the main body, the first limit member, or the second limit member; the opening is adapted to have the end of the cord tucked therein.

11. The driving module of claim 10, wherein the opening includes a wide end and at least one narrow end; the wide end is adapted to have the end of the cord tucked therein and then moved toward the at least one narrow end, while the at least one narrow end is adapted to have the end of the cord fixed thereat.

12. The driving module of claim 8, wherein the third wheel-shaped structure further comprises a guiding trough which is recessed into the main body, and is close to the cord-fixing portion; the guiding trough is adapted to guide the cord to form the second cord loops after forming the first cord loop.

13. The driving module of claim 9, wherein at least one of the first limit member and the second limit member is a first toothed disk, and one end of the second wheel-shaped structure has at least one second toothed disk; the first toothed disk and the at least one second toothed disks mesh with each other, whereby the third wheel-shaped structure and the second wheel-shaped structure are adapted to be operated along with each other through a meshing relationship between the first toothed disk and the second toothed disk.
